(19) United States
(12) Patent Application Publication
(10) Pub. No.: US 2010/0239728 A1
(43) Pub. Date: Sep. 23, 2010

(54) METHOD FOR ACTIVATING AND EMPTYING BEVERAGE PREPARATION HOLDERS

(75) Inventor: Gerbrand Kristiaan De Graaff, Lisse (NL)

Correspondence Address: FOLEY & LARDNER LLP, 777 EAST WISCONSIN AVENUE, MILWAUKEE, WI, 53202-5306, US

(73) Assignee: Sara Lee/DE N.V.

(21) Appl. No.: 12/602,484

(22) PCT Filed: May 30, 2008
(86) PCT No.: PCT/NL2008/050331

§ 371 Date: Jun. 2, 2010

(30) Foreign Application Priority Data
Jun. 1, 2007 (NL) 1033923

(51) Int. Cl. A47J 31/41; A47J 31/44

(52) U.S. Cl. 426/389; 99/295

(57) ABSTRACT

A system for preparing a predetermined amount of beverage suitable for consumption, which system is provided with an exchangeable holder (102) and an apparatus with a fluid dispensing element, with which the holder is detachably connected for dispensing under pressure a first fluid to a first mixing chamber (110) of the exchangeable holder. The holder is provided with a storage space (108) which is filled with a second fluid and a fluid communication (114) between the storage space and the first mixing chamber for dispensing the second fluid to the first mixing chamber. The system is designed for positioning the holder (102) in a first position and for then removing a removable seal (138) in the fluid communication (114) prior to bringing the holder (102) into the second position and thereupon dispensing the second fluid to the at least one mixing chamber (110).

The invention relates to a method and apparatus for activating and emptying an exchangeable beverage preparation holder which is provided with at least one storage space with an expellable medium.

Such a method and apparatus for activating and emptying exchangeable beverage preparation holders is known from NL 1029155 (C). Here, a system is involved for preparing a predetermined amount of beverage, provided with an exchangeable holder and an apparatus with which the holder is detachably connected for expelling, for instance under pressure, an expellable medium, such as a concentrate, from a storage space of the exchangeable holder. For forming a discharge opening, a removable seal is provided (provided in the form of a breakable skin) which opens as a result of the increase of pressure in the storage space. During opening of the discharge opening, this removable seal is in direct communication with the expellable medium. It has appeared that under circumstances, the required minimum pressure for opening the seal is higher than the desired maximum pressure for dosing the expellable medium. It may happen then that an important part of the expellable medium flows outward in a rather uncontrolled manner directly after the seal has opened, which can adversely affect the desired mixing of the expellable medium for forming the beverage to be prepared. Further, during mixing, the volume can be so large that the impact or drawing-in of air for achieving froth formation becomes impossible. With underdosing of the concentrate in the mixing chamber too, the quality of the froth decreases in that the froth becomes coarser and more instable. In addition, it also mars the possibilities to produce a layered product such as “coffee in layers” (milk on the bottom, then coffee and milk froth on top).

It is an object of the present invention to eliminate or improve a drawback of the state of the art. It is also an object of the present invention to provide alternative systems which are easier in manufacture and use and which furthermore can be designed economically. Alternatively, it is an object of the invention to provide the public with at least a useful option. More particularly, it is an object of the invention to carry out forming a discharge opening independently of emptying the storage space.

To that end, the invention provides a method for activating an emptying an exchangeable beverage preparation holder which is provided with at least one storage space with an expellable medium, wherein the method provides for:

supporting the holder in a first position;

forming a discharge opening in the storage space;

moving the holder from the first position to a second, supported position; and

emptying the storage space by expelling the expellable medium through the discharge opening.

Owing to this feature, the steps of opening the storage space and emptying it for the purpose of dosing take place completely separately from each other. Thus, the possibility is created to have the expulsion of the content from the storage space proceed in a better controllable manner. As alternative, with this, it has also become easier to carry out breaking of the seal of the discharge opening with mechanical means, if desired.

The invention further provides in an apparatus for carrying out the method, wherein the apparatus is provided with a supporting receptacle for a holder, which supporting receptacle is movable between a first position in which the discharge opening of the storage space is not in direct communication with the expellable medium and a second position in which the discharge opening is indeed in direct communication with the expellable medium.

Specific embodiments of the invention, such as they are included in the dependent claims, are an integral part of this description.

In the following, the invention is further elucidated with reference to the Figures in the accompanying drawing.

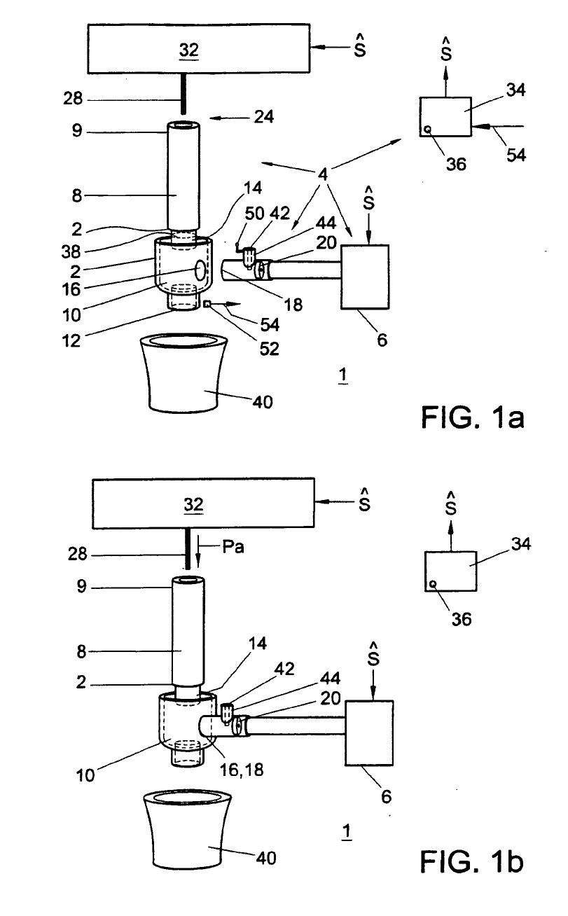

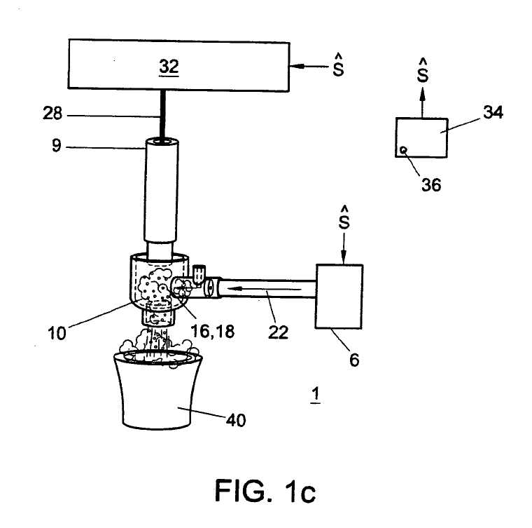

FIG. 1a schematically shows an example of an embodiment of a known system;

FIG. 1b schematically shows the system of FIG. 1a in an operative condition;

FIG. 1c schematically shows the system of FIG. 1a in another operative condition;

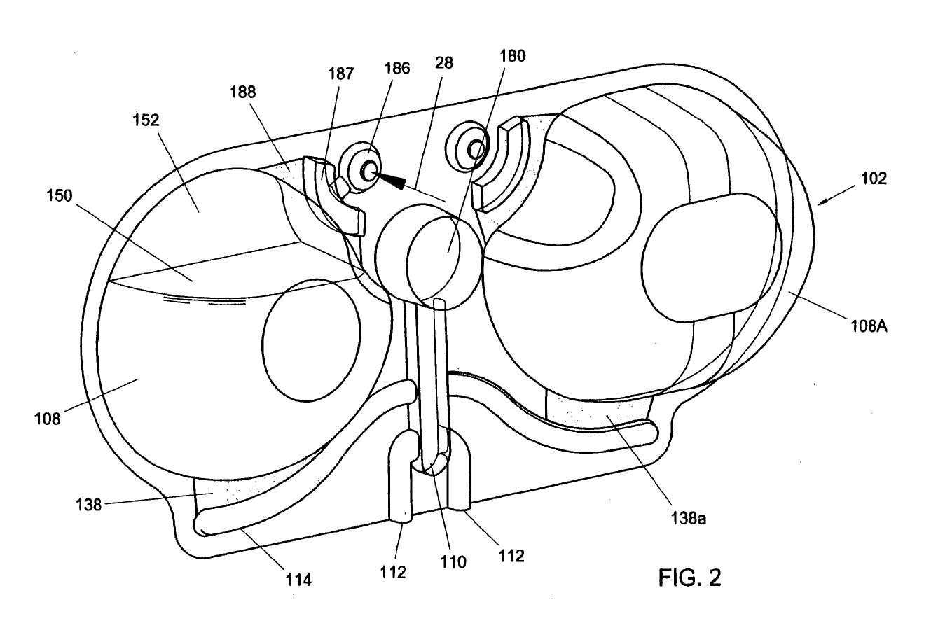

FIG. 2 shows an example of an exchangeable holder which is suitable to be used for the invention;

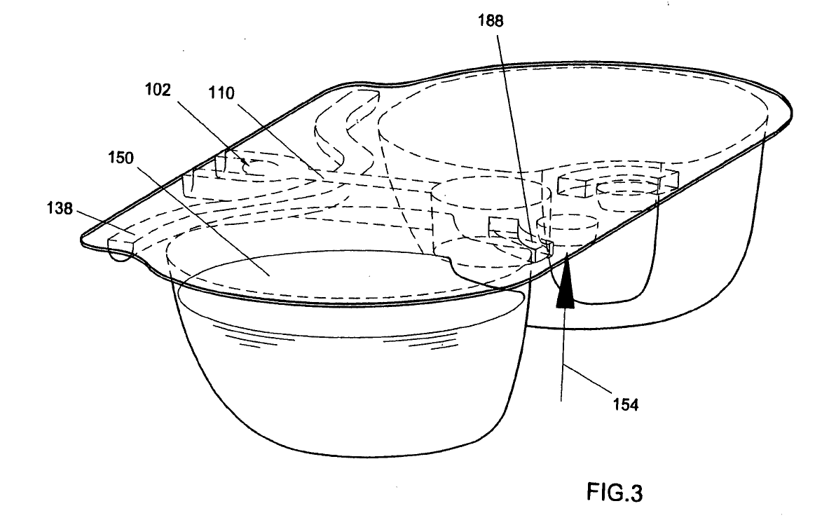

FIG. 3 shows the holder of FIG. 2 in a first position;

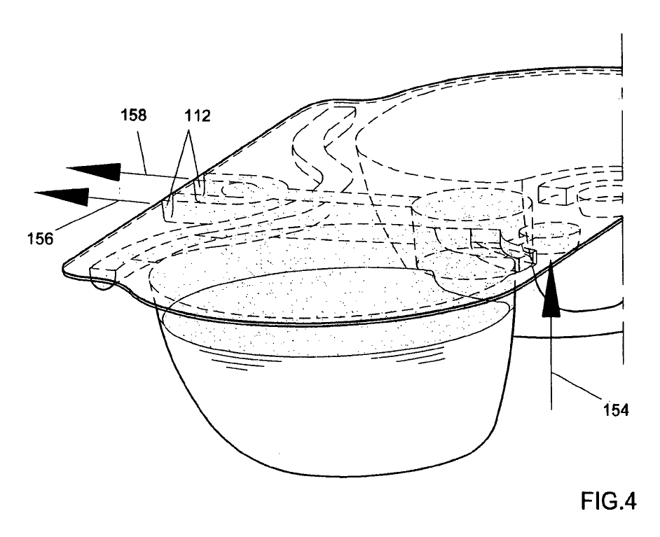

FIG. 4 shows a part of the holder according to FIG. 3 during formation of a discharge opening;

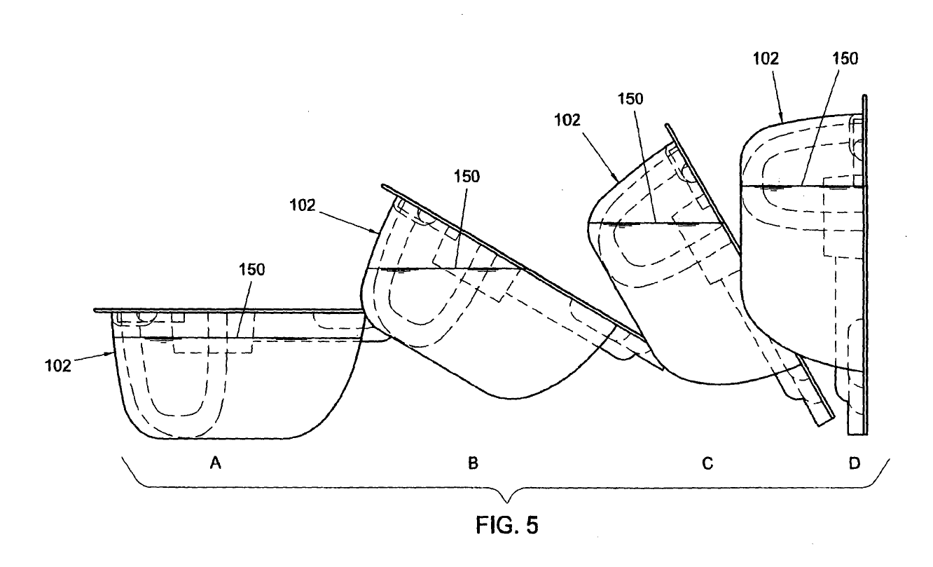

FIGS. 5a-5d show, in side view, four steps of the movement of the holder from the first position (5a) to the second position (5b); and

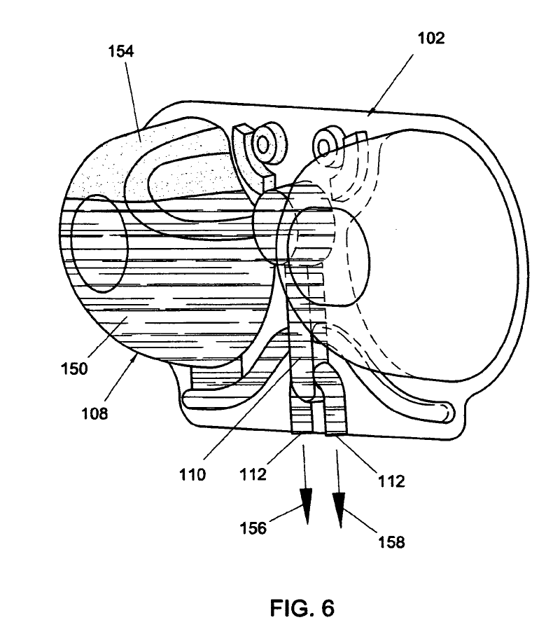

FIG. 6 shows the emptying and dosing of the content of the holder.

Presently, reference is first made to FIGS. 1a-1c. In these Figures, with reference numeral 1, a system for preparing a predetermined amount of beverage suitable for consumption is indicated. The system (see FIG. 1a) is provided with an exchangeable holder 2. In FIGS. 1a-1c, for the purpose of the initial description of the system and its operation, the holder 2 is represented only in a highly schematic manner.

The system is further provided with an apparatus 4 which is provided with, inter alia, a fluid dispensing element 6 which is designed for dispensing under pressure at least one amount of at least a first fluid, such as a liquid and/or a gas, more particularly such as water and/or steam. In this example, in use, the fluid dispensing element 6 dispenses water.

The exchangeable holder 2 is provided with at least one first storage space 8 which is filled with a second fluid, such as a beverage, a concentrate or a powder. In this example, a concentrate for preparing coffee is involved. The holder 2 is further provided with at least a first mixing chamber 10 and at least one outflow opening 12 which is in fluid communication with the first mixing chamber 10. The holder 2 is further provided with a fluid communication 14 between the first storage space 8 and the first mixing chamber 10. The holder 2 is further provided with at least one inlet opening 16 which is detachably connected to an outlet opening 18 of the fluid dispensing element 6. In FIG. 1a, the inlet opening 16 is not yet connected to the outlet opening 18. This is however the case in FIG. 1b. In this example, the inlet opening 16 in FIG. 1a is still sealed off by a seal that can be removed, such as a removable seal. This also holds for the outflow opening 12. In use, both removable seals are removed, whereupon the outlet opening 18 can be connected to the inlet opening 16 as shown in FIG. 1b. In this example, the system is further provided with a restriction 20 which is included in a fluid flow path 22 which extends via the outlet opening 18 of the fluid dispensing element 6, the inlet opening 16 and the first mixing chamber 10, from the fluid dispensing element 6 to the outflow opening 12.

More particularly, it holds in this example that the restriction 20 is included in a fluid flow path 22 which extends via the outlet opening 18 of the fluid dispensing element 6 and the inlet opening 16 of the exchangeable holder 2 from the fluid dispensing element 6 to the first mixing chamber 10.

The first storage space 8 forms at least a part of a dosing device 24 as will be explained hereinbelow in further detail. In this example, this dosing device 24 is further provided with a needle 28 which, in use, is pierced through a wall of the first storage space 8 for supplying a third fluid to the second fluid in the first storage space 8 for dispensing the second fluid to the first mixing chamber 10 in a dosed manner. In this example, the dosing device 24 is further provided with a fluid dispensing unit 32 which is connected to the needle 28. The fluid dispensing element 32 and the needle 28 form part of dosing means of the apparatus 4. In this example, the fluid dispensing unit 32 is, at least via the needle 28, detachably connectable to the holder 2.

The apparatus 4 is further also provided with a control device 34 for controlling the fluid dispensing element 6 and the fluid dispensing unit 32. For controlling the fluid dispensing element 6 and the fluid dispensing unit 32, the control device 34 generates control signals ŝ which are supplied to the fluid dispensing element 6 and the fluid dispensing unit 32. In this example, the control device 34 is designed for controlling the fluid dispensing element 6 and the fluid dispensing unit 32 independently of each other.

The system 1 described so far works as follows. For the purpose of preparing a predetermined amount of beverage suitable for consumption, the exchangeable holder 2 is placed in the apparatus 4. Here, the first storage space 8 of the exchangeable holder 2 is placed under the needle 28. Also, as shown in FIG. 1b, the outlet opening 18 is connected to the inlet opening 16. Now, the apparatus is ready for use. By pressing, for instance, a button 36 of the control device 34, the control device provides for the fluid dispensing unit 32 to start moving the needle 28 in the direction of the arrow Pa. The result of this is that the needle 28 is pierced through a wall of the first storage space 8 and the third fluid is supplied under pressure to the second fluid in the storage space. As a result, the third fluid will apply a pressure and/or force to the second fluid. As a result, in this example, the pressure in the first storage space 8 will increase. Here, the fluid communication 14 can for instance further be provided with a seal 38, in the form of, for instance, a breakable skin 38 which tears open as a result of the increase of the pressure in the first storage space 8 due to the supply of the third fluid. As a result, in this example, the coffee concentrate will flow in a dosed manner from the storage space 8 via the fluid communication 14 to the first mixing chamber 10. Simultaneously or soon after, the control device 34 provides for the fluid dispensing element 6 to be activated. This results in that the fluid dispensing element 6 starts dispensing the first fluid, in this case water, under pressure (FIG. 1c). In this example, this water is hot water with a temperature of, for instance, 80-98° C. This hot water flows via the fluid flow path 22 to the restriction 20. Having arrived at the restriction 20, a jet of the hot water is generated by means of the restriction 20. This jet spouts via the outlet opening 18 and the inlet opening 16 into the first mixing chamber 10. In the first mixing chamber 10, the hot water will start mixing well with the concentrate. Here, the flow rate at which the concentrate is supplied to the mixing chamber 10 is controlled by the control device 34 through control of the fluid dispensing unit 32. Further, the flow rate at which the hot water is supplied to the first mixing chamber 10 is also controlled by the control 34 through control of the fluid dispensing element 6. In the first mixing chamber, as a result of the jet, the concentrate will start mixing well with the hot water so that the beverage is formed. This beverage can then leave the outflow opening 12 and for instance be collected in a mug 40.

As with the system 1 according to the invention both the dosing of the concentrate in time can be controlled well and the dosing of the hot water in time can be controlled well, it can be effected that the concentration of the concentrate in the beverage can be accurately determined. Furthermore, it can be effected that the beverage that leaves the outflow opening 12 during the preparation thereof is of constant quality, i.e. the concentration of the concentrate in the beverage that is dispensed during dispensing can be kept substantially constant, if desired. The fact is that the flow rate of the water and the flow rate of the concentrate that are supplied to the mixing chamber 10 in this example can each, if desired, be controlled separately from each other. It therefore holds in this example that the system 1 is designed such that the fluid dispensing element 6 and the dosing device 24 can supply the first fluid and the second fluid, respectively, independently of each other to the first mixing chamber 10. This entails that the size of the flow rate of the first fluid and the period during which the first fluid is dispensed are independent (in this example through control of the control device) of the size of the flow rate of the second fluid and the period during which the second flow rate is dispensed. It further holds in this example, that the dosing device 24 involves a controllable and active dosing device for supplying the second fluid to the first mixing chamber by means of an increased pressure or force to the second fluid. Herein, an active dosing device is understood to mean that the second fluid flows through the fluid communication from the storage space to the first mixing chamber as a result of an excess pressure or force applied to the side of the storage space.

In the example, the system 1 is further provided with an air inlet opening 42. The air inlet opening 42 provides for the supply of air to the first mixing chamber 10 so that, in use, air is whipped into the beverage for obtaining a beverage with a fine bubble froth layer. Thus, for instance a café crème can be obtained. In this example, downstream of the restriction 20, the air inlet opening 42 is in fluid communication with the first mixing chamber 10. In this example, the air inlet opening 42 ends up, via a fluid communication 44, in the fluid flow path 22. In this example, it therefore holds that the air inlet opening 42 and the restriction 20 each form part of the apparatus 4. However, this is not required. It will be clear that the air inlet opening 42 and/or the restriction 20 can form part of the exchangeable holder 2.

After the preparation of the beverage, in this example coffee with a fine bubble froth layer, the control device 34 stops the fluid dispensing element 6. The control device 34 also effects that the third fluid is no longer supplied to the second fluid in the storage space and that the needle 28 is retracted from the respective wall of the first storage space 8, i.e. in a direction opposite to that of the arrow Pa. Here, it may be so that first, the control device 34 effects that the dispensing of the second fluid to the first mixing chamber is stopped and that after that, the supply of the first fluid (in this example water) is stopped. In this manner, the risk of the second fluid for instance contaminating the restriction 20 is reduced.

FIG. 1c shows a situation when the needle 28 is pierced through a wall of the first storage space 8 and the third fluid is supplied under pressure to the second fluid in the storage space 8. The situation shown occurs at the time when the control device 34 will stop the supply of hot water to the mixing chamber 10, will no longer supply the third fluid to the second fluid in the storage space 8 and will retract the needle 28 from the respective wall of the storage space 8 so that the holder 2 can thereupon be taken from the apparatus 4 again.

After this, a user can remove the exchangeable holder 2 and, if a new amount of beverage is to be prepared, can place a new exchangeable holder in the apparatus 4. The new exchangeable holder can be provided with a completely different type of second fluid such as, for instance, a milk concentrate. When, with the aid of the new exchangeable holder, milk is prepared in a manner comparable to that described for preparing coffee on the basis of coffee concentrate, in the prepared milk, no trace will be found of the type of the previously prepared type of beverage. The fact is that the first mixing chamber 10 forms part of the exchangeable holder and when a new exchangeable holder is placed in the apparatus 4, also, a completely new and hence clean first mixing chamber is placed in the holder. Therefore, contamination cannot be involved.

In the example of FIGS. 1a-1c, the dosing device 24 is designed for supplying the third fluid under pressure to the second fluid in the storage space 8 for dosed dispensing of the second fluid to the mixing chamber 10. It will be clear that additionally, or as alternative, the dosing device 24 can be provided with a compression unit for compressing the storage space 8 for dosed dispensing of the second fluid to the mixing chamber 10, as is described in, for instance, WO 2006/043808.

In the example of FIGS. 1a-1c, the jet of first fluid spouts into the first mixing chamber 10. It is possible that here, the jet impacts on an inner wall of the first mixing chamber 10, wherein swirls are formed in the first mixing chamber 10 resulting in that the second fluid, the first fluid and optionally air are mixed together. It is also possible that the jet impacts on a jet impact element in the first mixing chamber 10. Upon impact of the jet on the jet impact element, the liquid is atomized, so that air can be whipped in well.

As already mentioned, for the purpose of the initial description of the system and its operation, the holder 2 in the FIGS. 1a-1c is described only highly schematically. For a more detailed description of the invention in combination with an exchangeable holder suitable to be used to this end, reference is made to FIGS. 2-6.

FIG. 2 shows an exchangeable holder 102 which is suitable to be used with the invention in a position in which preferably emptying and dosing the content takes place. When referring to this position of the holder, in the following, the wording “upright position” or “second position” will be used. The parts of the holder 102 that correspond to the holder 2 shown in FIGS. 1a-1c will be indicated in FIGS. 2-6 with reference numerals that are increased by exactly one hundred. The holder 102 of FIGS. 2-6 has two outflow openings 112 and is designed as a blister pack with an appropriate number of deep-drawn blister chambers and a covering thereof. These are, however, optional details that can be varied without essential consequences for the use of the invention. The storage space 108, the first mixing chamber 110 and the fluid communication 114 between the first storage space 108 and the first mixing chamber 110 are each formed by one of the blister chambers. In this example, the first mixing chamber 110 is connected to the two outflow openings 112 via, for instance, two outflow channels formed by further blister chambers of the blister pack 102.

The blister pack 102 is further provided with the removable seal 138 for putting the fluid communication 114 in operation through removal of the sealing action of the removable seal 138. In the example shown, the removable seal 138 is a so-called “peel-seal” 138.

The fluid communication 114 is a channel which is not straight in longitudinal direction of the channel. In FIG. 2 for instance it is shown that the fluid communication 114 in longitudinal direction of the channel has a curvature in a plane parallel to the covering.

The blister pack 102 is further provided with a chamber 180 which is in communication, via the inlet opening 116, with the first mixing chamber 110. Via this chamber 180, the outlet opening 18 of the fluid dispensing element 6 can be connected to the inlet opening 116 with the aid of, for instance, a needle which is pierced through the cover as far as into the chamber 180. After this, the first fluid can be supplied to the mixing chamber 110.

The holder 102 is further provided with a chamber 186. This chamber 186 is in communication, via a zone 187, where the material from which the blister chambers are deep-drawn is not attached to the covering, with a second peel seal 188 that is similar to the above-mentioned first peel seal 138. The peel seal 188 is contiguous to the storage space 108. The needle 28 (see also FIG. 1) of the dosing device 24 can be pierced through a wall part of the chamber 186. Thus, the third fluid can be supplied to the chamber 186, whereupon the third fluid can be supplied under pressure and, after breaking of the second peel seal 188, to the first storage space 108. In this example, a relatively large effective surface of the second peel seal 188 is obtained onto which surface the pressure of the third fluid can effectively act for opening the second peel seal 188.

In FIG. 2, it can further also be seen that the storage space 108 is filled to a large extent with the second fluid in the form of a liquid, expellable concentrate 150 and that the rest of the storage space can be filled with a gaseous fluid 152, such as air, nitrogen or an inert gas.

As can also be seen in FIG. 2, the holder 102 can further be provided with an optional second storage space 108a, which is also connectable by means of a peel seal 138a to the mixing chamber 110. This second storage space 108a can, as shown, be designed with a form and/or size that deviates from the first storage space 108. It can thus be achieved that the consumer cannot inadvertently place the holder incorrectly in the beverage preparation apparatus. Through variation of the volume of the first and second storage space 108, 108a, it can further be provided that the liquid level in both chambers is the same or that the part not filled with an expellable fluid is geared in volume to the other chamber. This possibility of variation is especially useful when the beverage preparation ingredients in the first and second storage space are different.

FIG. 3 shows the holder according to FIG. 2 in its first position, which is further also indicated as “horizontal position”. In this position, the communication of the needle of the dosing device (see FIG. 1) to a wall part of the holder 102 is effected so that the third fluid can break the second peel seal 188, and can reach the first peal seal 138 via the storage space 108. This supply of the third fluid is schematically represented in FIG. 3 with the space arrow 154. Opening the first peel seal 138 with the third fluid takes place above the liquid surface of the second fluid 150, so that during the opening of the peel seal 138 second fluid 150 can not yet flow to the mixing chamber 110. The same advantage can be of importance when for the breakable seal of the discharge opening not a peel seal 138 is used but the discharge opening is formed with mechanical means. This may be the piercing of a wall of the storage space 108. In such a situation too, it is undesired when the concentrate to be dosed would escape through the formed discharge opening.

In FIG. 4, it is further elucidated how the holder according to FIG. 3, during formation of the discharge opening (138), is filled with the third, preferably gaseous, fluid that escapes via the outflow channels 112, as schematically indicated with the arrows 156 and 158. It has appeared that peel seals (138, 188) that withstand a pressure of at least 0.5 bar before opening, can also be sufficiently relied upon not to open in an undesired manner during the preceding transport or treatment of the holders. The properties of the peel seals (138, 188) are therefore selected accordingly.

FIGS. 5a-5d show, in side view, in four steps, the movement of the holder 102 from the first horizontal position A to a second upright position D (via the intermediate positions B and C).

FIG. 6 shows the upright position according to FIG. 5D during emptying and dosing of the content of the storage space 108 of the holder 102.

With the holder 102 in this position, together with the expulsion of the concentrate 150, also, the first fluid is supplied to the mixing chamber 110 with the aid of the third fluid (according to the arrow 154). It has appeared that in this upright position of the holder, the second fluid or concentrate 150 can be dosed well with a pressure of at most 0.3 bar.

With the described method and apparatus a dosing problem is avoided. It is no longer necessary to keep the pressure of the third fluid required for opening the peel seals within narrow tolerances as regards the dosing pressure to be limited. Further, also the volume of the plenum above the expellable second fluid in the storage space is no longer critical because no buffer is required for absorbing pressure peaks. For the length of the connecting channels, it also holds that this is no longer critical. The dosing pressure can be gradually built up from 0 bar and the dosing moment can thus be determined more accurately. Prior thereto, it can also be ensured that the breakable seals obtain their complete degree of opening.

It is supposed that with this the operation and the design of the invention clearly emerge from the preceding description.

However, the invention is not limited to any embodiment described herein, and, within the capacity of the skilled person, modifications are possible that are understood to fall within the scope of protection. Also, all kinematic inversions are understood to fall within the scope of protection of the present invention. Expressions such as “consisting of”, when used in this description or in the accompanying claims, should not be understood to have an exclusive or preclusive meaning, but rather an inclusive meaning. Expressions such as “means for . . . ”, “means (plural) for . . . ” etc. should be read as: “component formed for” or “element constructed for . . . ” and should be understood to also comprise the constructions described as equivalents. The use of expressions such as: “critical”, “advantageous”, “desired” etc, are not intended to delimit the invention. The properties that are not specifically or expressly described or claimed can furthermore be comprised in the construction according to the present invention without departing from the scope of protection.

1. A method for activating and emptying an exchangeable holder for preparation of a beverage, the method comprising:
providing at least one storage space with an expellable medium;
positioning the holder in a first orientation;
forming a discharge opening in the storage space when the holder is in the first orientation;
moving the holder to a second orientation; and
emptying the storage space by expelling the expellable medium through the discharge opening, when the holder is in the second orientation.

2. The method according to claim 1, wherein the expellable medium is supplied from the storage space to a mixing chamber and wherein the discharge opening is formed in a path between the storage space and the mixing chamber.

3. The method according to claim 1, further comprising forming an inlet opening in the holder which is in fluid communication with the storage space.

4. The method according to claim 3, wherein emptying the storage space comprises supplying a third fluid under pressure to the inlet opening so that in the storage space a pressure or force is applied by the third fluid to the expellable medium.

5. The method according to claim 4, wherein the expellable medium is formed by a liquid second fluid.

6. The method according to claim 4, wherein the discharge opening is formed by supplying a third fluid when the holder is in the first orientation and wherein the seal of the discharge opening will open when the pressure that is applied by the third fluid to the seal increases to above a predetermined minimum pressure.

7. The method according to claim 6, wherein the third fluid is the same for opening the seal and for expelling the expellable medium.

8. The method according to claim 6, wherein the third fluid is replaced by a fluid of a different kind.

9. The method according to claim 6, wherein the first predetermined minimum pressure is 0.5 bar.

10. The method according to claim 6, wherein after forming the discharge opening and prior to moving the holder to the second position, the supply of the third fluid is interrupted.

11. The method according to claim 10, wherein after moving the holder into the second position and prior to emptying the storage space, the supply of the third fluid is resumed with a predetermined maximum pressure.

12. The method according to claim 8, wherein the third fluid during formation of the discharge opening is a gaseous fluid, while the third fluid during emptying of the storage space is a liquid fluid.

13. The method according to claim 1, wherein the beverage is intended for human consumption.

14. The method according to claim 3, wherein the method is carried out mechanically.

15. The method according to claim 1, wherein the formed discharge opening is located, in the first orientation of the holder, at least for a part, above the expellable medium and, in the second orientation of the holder, is located below the expellable medium.

16. The method according to claim 4, wherein the third fluid is a gas.

17. The method according to claim 12, wherein the expellable medium is supplied from the storage space to a mixing chamber and the discharge opening is formed in a path between the storage space and the mixing chamber, with supply under pressure of at least an amount of at least the first fluid, such as a liquid and/or a gas, in particular such as water and/or steam, to the mixing chamber of the exchangeable holder and dosed supply of the second fluid from the first storage space to the mixing chamber, so that in the mixing chamber the first fluid and the second fluid mix together for obtaining the beverage which then leaves the exchangeable holder via the outflow opening.

18. The method according to claim 17, comprising placing the holder in a holder receiving part configured to detachably receive the holder for preparing a beverage suitable for consumption, which holder receiving part comprises recesses for including at least the first storage space, the mixing chamber and the first fluid communication, which recesses have contours, viewed in cross sections through a plane parallel to the first wall part of the holder received in the holder receiving part, that correspond at least partly with contours of said mixing chamber, the first storage space and the first fluid communication.

19. The method according to claim 18, wherein the contours of the holder receiving part correspond substantially completely with the contours of the first mixing chamber, the first storage space and the first fluid communication.

20. An apparatus for carrying out the method according to claim 1, further comprising a receiving part for detachably receiving and supporting the exchangeable holder, wherein the receiving part is movable between a first position in which the discharge opening of the storage space is not in direct communication with the expellable medium and a second position in which the discharge opening is in direct communication with the expellable medium.

21. The apparatus according to claim 20, wherein the formed discharge opening of the storage space communicates, at least in the second position of the holder, with a mixing chamber, which either forms part of the apparatus or is an integral part of the holder.

22. The apparatus according to claim 20, further comprising predetermined means cooperating with a holder for supply by the apparatus in a controllable manner, under pressure, of a third fluid to the second fluid in a storage space of this holder.

23. The apparatus according to claim 20, further comprising a code reading unit, for recognizing and reading a code provided on a holder, and a control device which controls the apparatus depending on the code read.

24. The apparatus according to claim 20, further comprising a control device for controlling the pressure of the third fluid.

25. The apparatus according to claim 24, wherein the control unit comprises a control of the amount and/or temperature of the fluids, which are operatively supplied to the holder.

26. The apparatus according to claim 20, further provided with further comprising a fluid dispensing element with an outlet opening which can be detachably connected to an inlet opening of a holder, of a predetermined model, for dispensing a first fluid under pressure.

27. A system for preparing a beverage suitable for consumption, the system comprising:
an apparatus, and
an exchangeable holder detachably connected to this apparatus,
wherein the apparatus includes a fluid dispensing element for dispensing under pressure at least a first fluid, such as a gas and/or liquid, to the exchangeable holder for preparing a beverage suitable for consumption,
wherein the exchangeable holder includes
at least a first storage space which is filled with a second fluid, such as a concentrate, wherein the holder comprises:
at least a first mixing chamber,
at least one discharge opening which is in fluid communication with the first mixing chamber for dispensing the beverage from the first mixing chamber,
at least a first fluid communication between the first storage space and the first mixing chamber for dispensing the second fluid to the first mixing chamber,
wherein between the storage space and the mixing chamber there is a removable fluid seal and at least one inlet opening which, in use, is detachably connected to an outlet opening of the fluid dispensing element for supplying the first fluid to the first mixing chamber,
wherein the first storage space, at least partly, forms part of a dosing device configured to supply dosed supply of the second fluid from the first storage space to the first mixing chamber,
wherein, in use, the first fluid is also supplied under pressure to the first mixing chamber so that the second fluid and the first fluid mix together for obtaining the beverage which then leaves the holder via an outflow opening,
wherein the holder is configured to be positioned in a first position and the removable seal removed prior to bringing the holder into a second position and thereupon dispensing the second fluid to the at least first mixing chamber.

28. The system according to claim 27, wherein the holder comprises a second storage space which is filled with a fourth fluid, such as a concentrate, and a second fluid communication between the second storage space and the first mixing chamber for dispensing the fourth fluid to the first mixing chamber, wherein the second storage space, at least partly, forms part of a dosing device configured to supply dosed supply of the fourth fluid from the second storage space to the first mixing chamber, wherein, in use, the first fluid is also supplied under pressure to the first mixing chamber so that, on the one side, the second fluid and/or the fourth fluid and, on the other side, the first fluid mix together for obtaining the beverage which then leaves the holder via the outflow opening.

29. The system according to claim 26, wherein the holder comprises a fifth wall part that extends at least substantially along an imaginary flat plane, wherein the fifth wall part bounds a first part of the second storage space and wherein the holder comprises a sixth wall part that bounds a second part of the second storage space, wherein a height of the first mixing chamber with respect to the first wall part is smaller than a height of the second storage space with respect to the fifth wall part.

30. The system according to claim 28, wherein the first mixing chamber is located between the first storage space and the second storage space.

31. The system according to claim 27, wherein the holder is designed as a blister pack.

32. The system according to claim 27, wherein the holder is configured so that, in use, in a controllable manner by the apparatus, under pressure, a third fluid can be supplied to the second fluid in the first mixing chamber for dosed dispensing of the second fluid from the first storage space to the first mixing chamber.

33. The system according to claim 32, wherein the holder is configured so that, in use, the second fluid can be supplied in a dosed manner from the first storage space to the first mixing chamber by means of pressurizing the second fluid with the pressure of the third fluid.

34. The system according to claim 27, wherein the holder is configured so that, in use, in a controllable manner by the apparatus, under pressure, a fifth fluid can be supplied to the fourth fluid in the second storage space for dosed dispensing of the fourth fluid from the second storage space to the first mixing chamber.

35. The system according to claim 34, wherein the holder is configured so that, in use, the fourth fluid can be supplied in a dosed manner from the second storage space to the first mixing chamber by means of pressurizing the fourth fluid with the pressure of the fifth fluid.

36. The system according to claim 27, further provided with further comprising a holder receiving part configured to detachably receive the holder for preparing a beverage suitable for consumption, which holder receiving part comprises recesses with contours for receiving at least the first storage space, the first mixing chamber and the first fluid communication, wherein the contours of the holder receiving part correspond substantially completely with the contours of the first mixing chamber, the first storage space and the first fluid communication.
